(19) United States
(12) Patent Application Publication
(10) Pub. No.: US 2009/0320764 A1
(43) Pub. Date: Dec. 31, 2009

(54) Pig feeder with arrangement for preventing feed material from becoming clogged

(76) Inventor: Jung Wei Chang, Taichung (TW)

Correspondence Address: SAM CHEN, 7F-1, 293, ROOSEVELT ROAD, SEC 3, TAIPEI, TW

(21) Appl. No.: 12/164,100

(22) Filed: Jun. 29, 2008

(51) Int. Cl. A01K 1/10

(52) U.S. Cl. 119/53.5

(57) ABSTRACT

A pig feeder includes a feed collection pan including a central truncated cone, a disk secured onto the top of the central truncated cone and having an area larger than that of the top of the central truncated cone, and at least one bottom post between a peripheral wall of the pan and the central truncated cone; a support assembly secured to the wall; a feed storage hopper secured by the support assembly and having a lower pivotal tube above the disk wherein feed material in the hopper is adapted to discharge into the pan via the disk by pivotably pushing the tube; and a water supply duct having at least one valve each above the post and adapted to open by pivotably pushing. Feed material is prevented from becoming clogged even after a period time of inoperative.

### BACKGROUND OF THE INVENTION

1. Field of Invention

The invention relates to animal feeding devices and more particularly to a pig feeder having an arrangement for preventing feed material stored therein from becoming clogged due to drying.

2. Description of Related Art

A conventional pig feeder is shown in FIGS. 1 and 2 and comprises a shallow circular feed collection pan 30 including a central raised hollow truncated cone-shaped portion 31; a support assembly 20 having four equally spaced, inverted L-shaped legs (not numbered) having a bottom end fixedly secured to the top edge of the feed collection pan 30 and a top central ring (not numbered) interconnecting the top ends of the legs; a feed storage hopper 10 securely seated upon the ring of the support assembly 20 and having a lower tube 11 pivotably attached to its bottom; and a water supply duct 21 having two opposite end valves 22 each located between one leg and the tube 11 about flush with the bottom of the tube 11.

Feed material 40 is slowly and evenly discharged from the bottom opening of the tube 11 of the hopper 10 onto the bottom of the pan 30 via a space 32 between the tube 11 and the truncated cone-shaped portion 31 as animals (e.g., pigs) pivotably push the tube 11 by the snouts in feeding time. Moreover, the pigs may use the snouts to open the valves 22 by pivotably pushing in order to let water flow into the feed material 40 to mix so as to form a wet feed material for ease of eating.

Water in the feed material 40 on the pan 30 may permeate into the tube 11 via the space 32 which is filled with the feed material 40. However, feed material in the hopper 10 and/or feed material in the space 32 may become dried and even clogged after a period time of inoperative due to drying. A manual removal of the obstructions is required and it is not desirable.

There have been numerous suggestions in prior patents for animal feeder. For example, U.S. Pat. Nos. 4,433,641, 4,462,338, 4,729,344, and 5,850,805 all disclose an animal feeding device. Thus, continuing improvements in the exploitation of animal feeder are constantly being sought.

### SUMMARY OF THE INVENTION

It is therefore one object of the invention to provide a pig feeder having an arrangement for preventing feed material stored in a feed storage hopper from becoming clogged due to after a period time of inoperative.

The above and other objects, features and advantages of the invention will become apparent from the following detailed description taken with the accompanying drawings.

### BRIEF DESCRIPTION OF THE DRAWINGS

FIG. 1 is a perspective view of a conventional pig feeder;

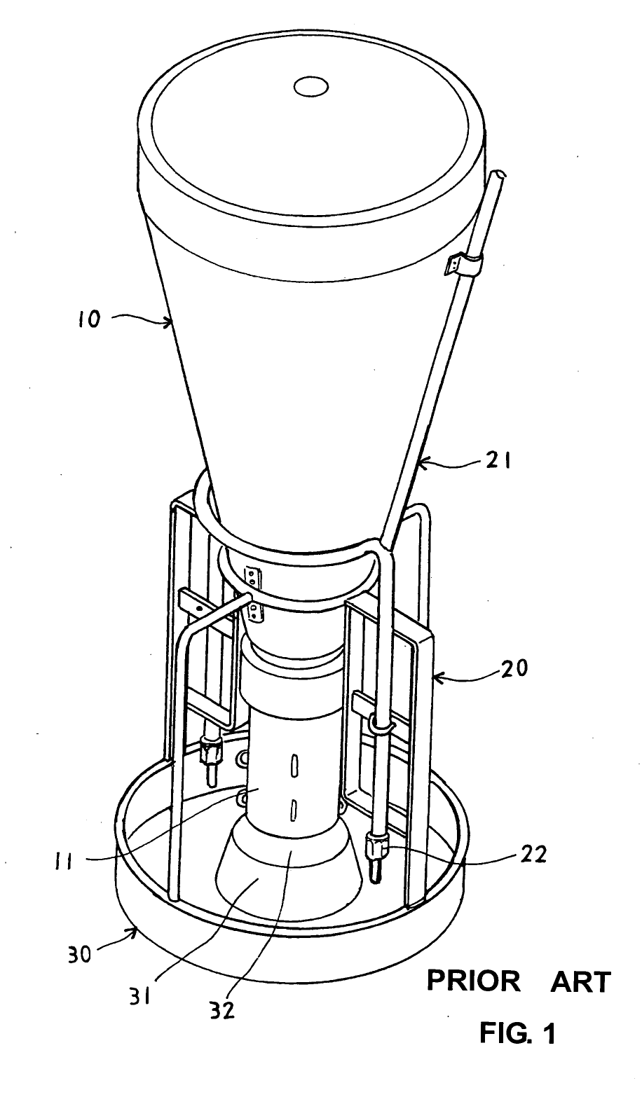

FIG. 2 a side elevation in part section of FIG. 1;

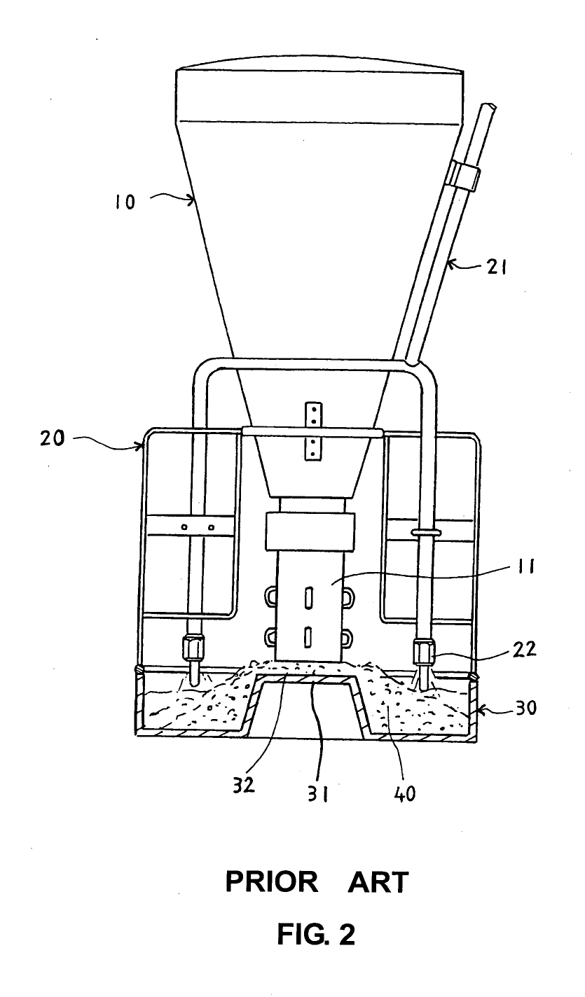

FIG. 3 is a perspective view of a preferred embodiment of pig feeder according to the invention; and

FIG. 4 a side elevation in part section of FIG. 3.

### DETAILED DESCRIPTION OF THE INVENTION

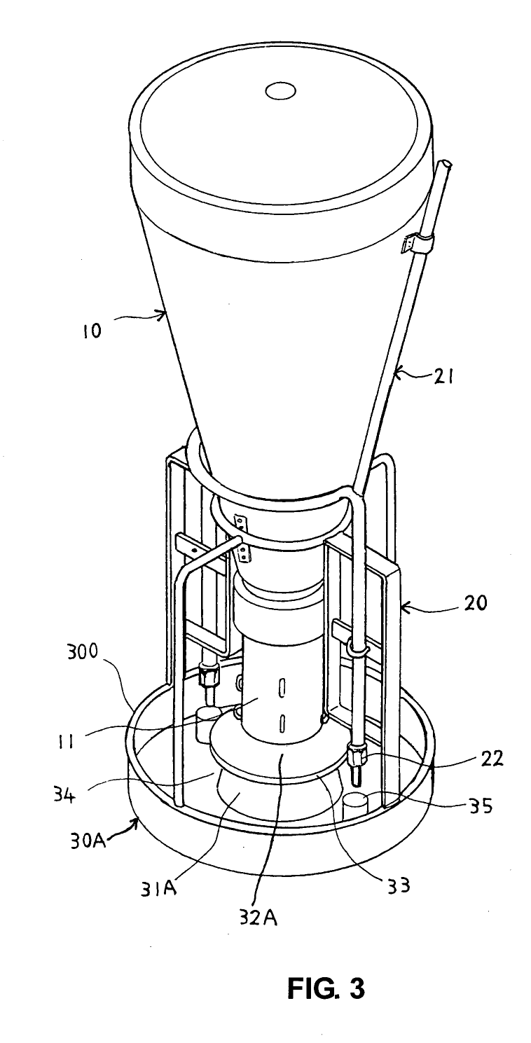

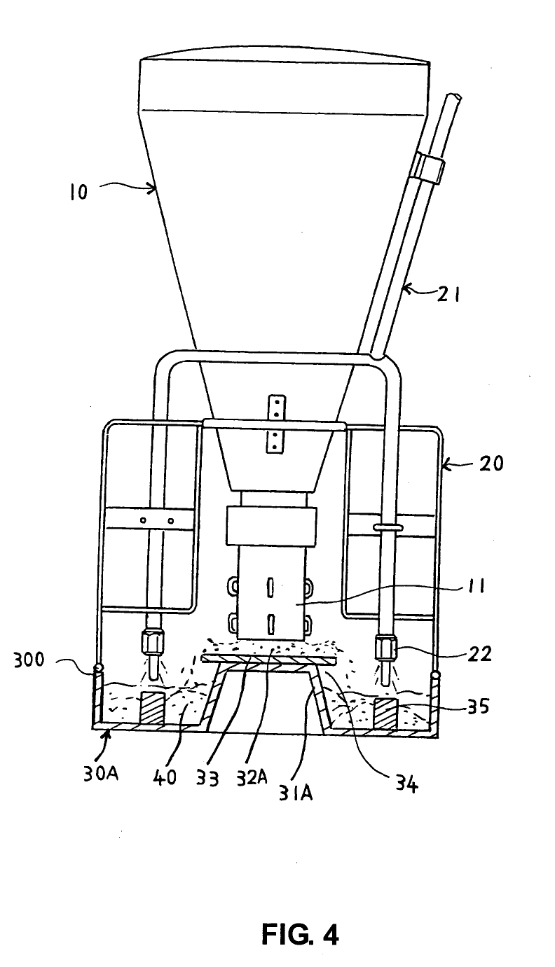

Referring to FIGS. 3 and 4, a pig feeder in accordance with a preferred embodiment of the invention comprises the following components as discussed in detail below.

A shallow circular feed collection pan 30A comprising a peripheral wall 300, a central raised hollow truncated cone-shaped portion 31A integrally formed with the bottom, a disk 33 secured onto the top of the central raised hollow truncated cone-shaped portion 31A, and opposite bottom posts 35 each located between the wall 300 and the central raised hollow truncated cone-shaped portion 31A. The post 35 has a height less than that of the central raised hollow truncated cone-shaped portion 31A. Preferably, the post 35 has a height about half of that of the central raised hollow truncated cone-shaped portion 31A. The disk 33 has an area larger than that of the top of the central raised hollow truncated cone-shaped portion 31A. Hence, there is a peripheral shoulder 34 formed between the underside of the disk 33 and the top peripheral edge of the central raised hollow truncated cone-shaped portion 31A. Preferably, the area of the disk 33 is one and one-fourth larger than that of the top of the central raised hollow truncated cone-shaped portion 31A.

A support assembly 20 has four equally spaced, inverted L-shaped legs (not numbered) having a bottom end fixedly secured to the top of the wall 300 and a top central ring (not numbered) interconnecting the top ends of the legs. A feed storage hopper 10 is securely seated upon the ring of the support assembly 20 and has a lower tube 11 pivotably attached to its bottom. A water supply duct 21 has two opposite end valves 22 each located between one leg and the tube 11 just above the post 35 by a predetermined distance.

Feed material 40 is slowly and evenly discharged from the bottom opening of the tube 11 of the hopper 10 onto the bottom of the pan 30A via a space 32A between the tube 11 and the disk 33 as animals (e.g., pigs) pivotably push the tube 11 by the snouts in feeding time. Moreover, the pigs may use the snouts to open the valves 22 by pivotably pushing in order to let water flow into the feed material 40 to mix so as to form a wet feed material for ease of eating.

Water is allowed to permeate the feed material 40 on the pan 30. Advantageously, water is not allowed to pass into feed material stored in the hopper 10 since a gap is generally formed between the disk 33 and the top of the feed material 40 in the pan 30A. That is, the path of permeation is blocked by the gap. Hence, wetness of feed material on the top of the disk 33 and wetness of feed material in the hopper 10 are substantially maintained at the desired degree. Hence, feed material clogging is prevented from occurring.

It is understood that pigs will not open the valves 22 by pivotably pushing if feed material 40 in the pan 30A is sufficiently wet. However, as experienced in the conventional pig feeder, the short legs of a pig may accidentally open the valves 22 by kicking. Advantageously, the provision of the posts 35 can prevent this from occurring. Hence, wetness of feed material in the pan 30A is substantially maintained at a desired degree.

It is contemplated by the invention that both feed material in the hopper 10 and feed material on the disk 33 are prevented from becoming clogged after a period time of inoperative.

While the invention herein disclosed has been described by means of specific embodiments, numerous modifications and variations could be made thereto by those skilled in the art without departing from the scope and spirit of the invention set forth in the claims.

What is claimed is:

1. A pig feeding device comprising:
a feed collection pan including a central truncated cone, a disk secured onto the top of the central truncated cone and having an area larger than that of the top of the central truncated cone, and at least one bottom post disposed between a peripheral wall of the feed collection pan and the central truncated cone;
a support assembly fixedly secured to the peripheral wall of the feed collection pan;
a feed storage hopper secured by the support assembly and having a lower pivotal tube disposed above the disk by a predetermined distance wherein feed material in the feed storage hopper is adapted to discharge into the feed collection pan via the tube and the disk by pivotably pushing the tube; and
a water supply duct having at least one valve each located above the post by a predetermined distance wherein each of the at least one valve is adapted to open by pivotably pushing.

2. The pig feeding device of claim 1, wherein the area of the disk is about one and one-fourth larger than that of the top of the central truncated cone.

3. The pig feeding device of claim 1, wherein the height of each of the at least one post is about half of that of the central truncated cone.
